(19) United States
(12) Patent Application Publication
(10) Pub. No.: US 2004/0078290 A1
(43) Pub. Date: Apr. 22, 2004

(54) Warranty managing process

(76) Inventor: David J. Mester, Fowlerville, MI (US)

Correspondence Address: Daniel J. Donahue, Detroit Diesel Corporation, 13400 Outer Drive West, Detroit, MI, 48239-4001, US

(21) Appl. No.: 10/617,472

(22) Filed: Jul. 11, 2003

Related U.S. Application Data
(60) Provisional application No. 60/398,844, filed on Jul. 26, 2002.

(51) Int. Cl. G06F 17/60

(52) U.S. Cl. 705/26

(57) ABSTRACT

The warranty managing process includes a method of processing a customer claim against a manufacturer's product that includes the steps of inputting the claim through a computer to a database at a first management level, determining the value of the claim, and acting to approve or deny the claim at the first management level when the value of the claim is below a first predetermined amount. A second management level acts to review all claims input at the first management level and acts to approve or deny the claim when the value of the claim is above the first predetermined amount and below a second predetermined amount. A third management level acts to review all claims input at the first and second management levels and acts to approve or deny the claim when the value of the claim is above the second predetermined amount when the value of the claim is above the second predetermined amount.

This application claims the benefit of provisional application U.S. Serial No. 60/398,844 entitled WARRANTY MANAGING PROCESS filed Jul. 26, 2002.

### BACKGROUND OF THE INVENTION

1. Field of the Invention

The invention relates, generally, to a method for processing customer claims against manufactured products and, more specifically, to a method of processing customer claims seeking repair or replacement after the expiration the manufacturer's warranty period or claims seeking recovery of ancillary costs incurred during the warranty period.

2. Description of the Related Art

In the production of goods, all manufacturers must deal with the certain implied and underlying legal business concepts such as a warranty of merchantability and warranty of fitness for a particular purpose. These concepts are legally established protections for the consumer that help to help guard against poor business practices and outright fraud. However, legitimate and well-established businesses that desire to build a strong reputation for the production of quality products and that seek to establish and maintain goodwill with the customers that they serve generally go well beyond the legally established minimums and offer express warranties and protection policies to their customers. Generally, the express warranties that are extended to the consumer offer specific coverage for products or portions of products over a given time period, most often with a repair or replacement remedy for products that fail or stop working properly within their given scope and purpose. In practice, these limited express warranties offer protections to both the consumer and the manufacturer. The consumer is protected if the product fails within the warranty period in that the failure will be corrected without any additional, or perhaps with only a minimal, expense. This gives consumers an assurance that they are receiving a product that should have a minimum service life for at least the time period established by the warranty. These warranties are typically very successful in instilling consumer confidence and faith in a product or a brand name and developing a consumer following.

The warranty protects the manufacturer by its time limitation. Generally speaking the manufacturer strives to produce a product with the inherent quality to functionally perform beyond the expiration of the warranty period. However, the end of the warranty period releases the manufacturer from maintaining the product indefinitely. While some small or simplistic consumer goods come with “lifetime guarantees,” the manufacturers of more sophisticated, complex, or expensive goods, such as motor vehicles, electronics devices, or industrial equipment, for example, offer their products with much more limited warranties. The limitations of these warranties are usually based on a reasonableness concept of offering the consumer fair warranty protection without overburdening the manufacturer. However, it is the manufacturer's reasonableness approach that can bring about difficulties in consumer relations directly affecting the reputation and perceived goodwill that the manufacturer is trying to develop and maintain.

With any warrantied product there comes a time at which the product reaches the expiration date of the manufacturer's express warranty. In the time frame immediately following the expiration of the warranty, it is possible for a well-manufactured product to fail, even if it has been well cared for by the consumer. A failure shortly after the end of the warranty period is sometimes due to the fact that the time that the manufacturer sets for the expiration of the warranty is close to the practical life expectancy of the product. This product failure scenario presents a conundrum to both parties. First, the consumer is faced with the full economic burden of repairing or replacing the product yet usually feels that there should be some obligation on the part of the manufacturer to offer compensation or recompense due to the recent warranty expiration. Secondly, even though the manufacturer's obligation has already been completed by producing a usable product that has met expectations and provided a fair service life, it may seek to maintain customer satisfaction. Thus, while the manufacturer may not be legally or ethically obligated to take on any further costs involved with the repair or replacement of the product beyond its warranty, the relationship with the customer must be considered.

The resolution of this scenario will test the reputation and perceived goodwill of the manufacturer. Whether or not the manufacturer will voluntarily offer some compensation for a product that has failed a short time after the expiration of the warranty will directly affect further relations with the customer. For the manufacturer, this generally becomes a balance of economic factors A strict adherence to the terms of the limited warranty and a denial of an after-warranty claim by the manufacturer will save any further costs, but will usually result in some amount of customer dissatisfaction. This customer dissatisfaction with the manufacturer will most likely result in a loss of further business with the particular customer, and may escalate into consumer dissatisfaction on a larger scale. Particular individual customer dissatisfaction may also be compounded when the customer owns a number of the manufacturer's product or buys in volume. In this respect, the perceived goodwill of the manufacturer towards a single customer may not merely be a singular, isolated concern but one that translates into an issue of considerable economic weight for the manufacturer.

To address this, manufacturers have typically developed some process or policy of dealing with customer requests for consideration and reimbursement of costs in after-warranty issues. These policies are most often based on the notion that a good reputation and perceived goodwill that stems from good consumer relations do have a tangible economic value that greatly outweighs any cost savings found in denying these after-warranty claims. In other words, it costs far less to reimburse or partially reimburse a reasonable after-warranty claim as an expression of good will, than to maintain revenue by denying claims while losing valuable customers. Even though manufacturers acknowledge the value in this type of policy, the processes for dealing with it are often setup informally and fall indiscriminately to different or varying levels of management.

Typically, the process is tracked using paper forms with little or no formalized control, such as a readily assessable computer database system, until the approved claim submissions reach an accounting department. Additionally, a non-formalized, poorly defined policy of this type requires ad hoc decisions to be made about which claims to honor and at what level of reimbursement, often at higher management levels far removed from the customer. This approach is very inefficient and often burdens higher levels of management by requiring that a review of each claim approved be performed up through each level of management.

The typical policy, or after-warranty, claim systems also are inadequate when a manufacturer's interests and markets are far-reaching and far-flung from the central corporate structure, such as when a manufacturer operates a national distributorship system for sales and service of the manufactured product. In this case, requests for policy consideration come from many different avenues and are often submitted to the corporate body in a variety of formats, such as fax, e-mail, regular mail, or inter-office mail. The scattered paper trail through a variety of submission formats causes claim repetition, misdirection, or even loss. This creates further inefficiencies and additional costs as more and more time is required of all departments and management levels to control the paper flow. There is also often inadequate claim tracking or reporting so that there are little, if any, checks and balances to control and monitor paid out after-warranty claims. Also, without adequate claim tracking or the use of a readily accessible database, the useful technical information submitted with the claims relating to the cause and nature of product failures beyond the warranty cannot be retrieved and utilized.

Even when a policy claim system is more formalized and structured, the method of tracking and accounting of the after-warranty claims are still commonly outside any established warranty repair or replacement claims process, such that after-warranty claims are not administratively tracked and monitored efficiently. This problem is magnified by a corresponding scenario in which the failed product is still under its limited warranty, but the failure causes the customer secondary or additional costs, such as towing, labor repair costs, shipping and handling, or lost profits, for example. While the limitations of the warranty often expressly deny these types of claims, the manufacturer must still consider the value of offering some “off-warranty” compensation beyond the covered repair or replacement of the product. These off-warranty policy considerations relate to good consumer relations and perceived goodwill just as the after-warranty policy issues mentioned above. However, the conventional means for implementing, managing, monitoring, and tracking them also suffer from the same drawbacks and inefficiencies as the above-mentioned after-warranty policy processes.

Therefore, there is a need for a structured warranty managing process that can provide a way to efficiently enter customer after-warranty and off-warranty claim information from any of a wide variety of sources into a standardized format within an easily assessable database. There is also a need for a process in which the submitted claim data can be entered into a database at lower management levels, in closer association with the customer, so that claims can be organized and decided upon in the lower management levels. There is also a need for a process that can efficiently and quickly route the claims through a specific predetermined hierarchy of management levels for review so that a claim can be analyzed, validated and paid in a timely manner. There is also a need for a policy process to provide a system of checks and balances so that claims are not lost or do not languish. There is also a need for a process that stores claim data so that technical information can be extracted and used in the same manner as warranty claim data.

### SUMMARY OF THE INVENTION AND ADVANTAGES

The present invention overcomes the disadvantages of the related art in a providing a warranty managing process. The warranty managing process includes a method of processing a customer claim against a manufacturer's product that includes the steps of inputting the claim through a computer to a database at a first management level, determining the value of the claim, and acting to approve or deny the claim at the first management level when the value of the claim is below a first predetermined amount. A second management level acts to review all claims input at the first management level and acts to approve or deny the claim when the value of the claim is above the first predetermined amount and below a second predetermined amount. A third management level acts to review all claims input at the first and second management levels and acts to approve or deny the claim when the value of the claim is above the second predetermined amount when the value of the claim is above the second predetermined amount. Thus, the warranty managing process includes a plurality of steps that move customer after-warranty and off-warranty claims through various levels of the corporate structure for review and disposition. This provides a formalized process to start the claim at the lower management levels for approval or denial and then expeditiously moves the claim through the higher management levels for review.

The warranty managing process further includes the advantage of using a computer system having a local network with at least one database for the storage of information, and provides internet access through a corporate website. This provides access and retrieval of the entered data from the database by each of the plurality of corporate levels for processing, monitoring and control of the warranty managing process at any time from any location in which a computer with internet access is available. Still another advantage is that the readily available database allows a particular management level to process, monitor, and control the claims that their level is responsible for and also all the claims in the management level below.

### BRIEF DESCRIPTION OF THE DRAWINGS

Other advantages of the invention will be readily appreciated as the same becomes better understood by reference to the following detailed description when considered in connection with the accompanying drawings, wherein:

FIG. 1 is a schematic representation of a corporate computer system having a local network and including access to the Internet;

FIG. 1A is a flowchart of a corporate hierarchy for the warranty managing process of the present invention;

FIG. 2 is a flowchart of the steps of the warranty managing process of the present invention;

FIG. 3 is a screen shot of an internet web page of the present invention showing a corporate manufacturer's main menu;

FIG. 4 is a screen shot of an internet web page of the present invention showing a corporate manufacturer's main extranet menu for a registered user;

FIG. 5 is a screen shot of an internet web page of the present invention showing a corporate manufacturer's extranet menu for a Return Parts Management System (RMPS);

FIG. 6 is a screen shot of an internet web page showing a distributor's main menu for a policy process of the present invention;

FIG. 7 is screen shot of an internet web page showing a policy header page for the entry of customer claim data for a policy process of the present invention;

FIG. 8 is screen shot of an internet web page showing a policy narrative page for the entry of customer claim data for a policy process of the present invention;

FIG. 9 is screen shot of a pop-up window used within the warranty managing process of the present invention for notifying a distributor when an approval limit has been exceeded;

FIG. 10 is screen shot of an information window used within the warranty managing process of the present invention for verifying with a user the desired email addresses for the forwarding of claim reports;

FIG. 11 is screen shot of an internet web page showing a regional manager's main menu for a policy process of the present invention;

FIG. 12 is screen shot of an internet web page showing a corporate manager's main menu for a policy process of the present invention; and

FIG. 13 is screen shot of an internet web page showing a warranty administrator's main menu for a policy process of the present invention.

### DETAILED DESCRIPTION OF THE PREFERRED EMBODIMENT(S)

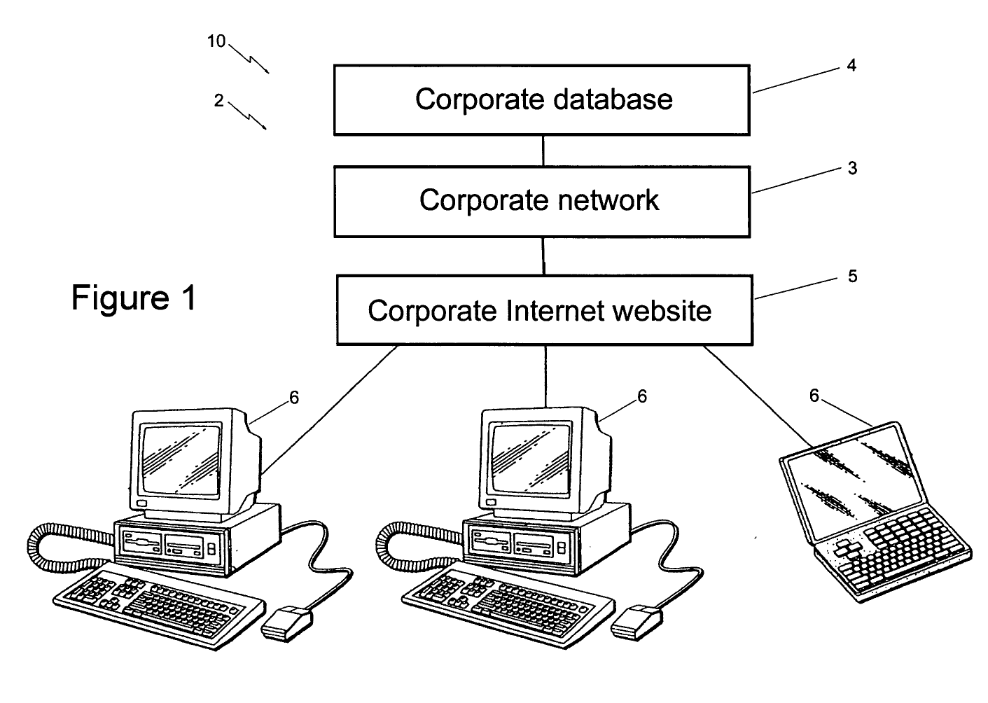

A warranty managing process of the present invention is generally indicated at 10 in FIGS. 1-4. The warranty managing process 10 is a business management process for the handling of claims made against manufactured products that have failed after the expiration of the manufacturer's express warranty period or for claims made for ancillary costs relating to failures of manufactured products while under warranty. Thus, the warranty managing process 10 operates as a corporate policy for the review and consideration of customer claims made outside the coverage of any expressed warranty and is also referred to as the “policy” process.

As schematically illustrated in FIG. 1, the warranty managing process 10 of the present invention employs the use of a computer system, generally indicated at 2. The computer system 2 includes a local corporate network 3 and at least one corporate database 4 for the storage of information. The corporate network 3 includes access to the World Wide Web through the “Internet” and has an established corporate website as indicated at 5. In this manner, the corporate website 5 provides access to the corporate network 3 and provides data entry capability to the corporate database 4. Thus, the computer system 2 allows access from any remote site having Internet capabilities or from a local corporate, Internet-capable computer as indicated at 6. The corporate internet website 5 further provides access and retrieval of the entered data from the corporate database 4 by each of the plurality of corporate levels for processing, monitoring and control of the warranty managing process of the present invention as will be discussed in greater detail below. It should be appreciated that the corporate network 3 may be established in any one of a variety of known computer interface network structures, such as an “intranet” or local area network (LAN) for example, so that local, in-house corporate computer access need not be routed out to the Internet for access.

The warranty managing, or policy, process 10 works within a portion of the administrative or corporate structure of a manufacturing company that utilizes a plurality of management levels. As shown in FIG. 1A and to best illustrate the present invention, the warranty management process 10 may be applied to a corporate manufacturing company 12 that has a distributorship system 14 for sales and service of its products and that utilizes an established computer network or intranet system which provides computer access through an Internet web site.

The warranty managing process 10 may also work cooperatively with a warranty repair and replacement system which processes claims against active product warranties. The warranty repair and replacement system is beyond the scope of this invention and is only discussed here as it relates to the present invention. It should be appreciated by those having ordinary skill in the art that while the present invention, as detailed in this specification, is a stand-alone process with its own corporate functionality and its own computer database structure for the storage and manipulation of data, that it may also share portions of the same database with the aforementioned warranty repair and replacement system, corporate accounting systems, and engineering departments so that data may be directly shared and cooperatively used for any of a variety of purposes.

It should be further appreciated that based upon the application of the warranty managing process 10 within a distributorship system 14, some of the levels are internal, or in-house management levels and some are external levels physically located in regional offices and at distributorship sales and service sites. It should be still further appreciated that the following outlined corporate hierarchy may or may not also exist for other corporate functions beyond the present invention, so that the following description is not a limitation to, or limited by, other corporate structures within the corporate body.

The first management level for the warranty managing process 10 of the present invention is the distributor level 20. The distributor level 20 includes all of the distributors responsible for sales and service of the corporate manufacturer's product. The distributors are often independent contractors representing the corporate manufacturer and may be an individual distributor 22, or may be a contracted distributorship site 24 having a sales and service force with more than one distributor 22 generally controlled by a distributor manager 26. Within the distributor level 20 there are groups 28 of individual distributors 22, distributor sites 24, or both, generally organized by their physical location within a regional territory. These regional distributor groups 28 organizationally answer to an individual regional manager 32 within a second management level. The second management level is thus referred to as the regional manager level, as indicated at 30 and includes individual regional managers 32 that are typically corporate employees who may be physically located in-house at a corporate headquarters or at various regional sites across the country or globally depending on the corporate structure and size. Each regional manager 32 is responsible for their specific regional distributor groups 28 that fall into their predetermined region.

The individual regional managers 32 of the regional level 30 organizationally answer to the corporate manager 42 within a third management level. The third management level is thus referred to as the corporate manager level, as indicated at 40. Based on the overall arrangement of the corporate structure and size of the corporation 12, there may be more than one corporate manager 42 responsible for all the regions represented within the regional level 30. In this manner, a single corporate manager 42 may control all of the regional managers 32, or two or more corporate managers 42 may share the regional responsibilities by each controlling groups of regional mangers 32 within the regional level 30.

For purposes of the warranty managing process 10 of the present invention, the corporate manager, or managers, 42 organizationally cooperate with the warranty administrator 52 within a fourth management level. The fourth management level is referred to as the warranty administration level 50. The warranty administrator 52 is generally a single individual responsible for monitoring all of the warranty claims, after-warranty claims, and off-warranty claims, as described above. It should be appreciated that the warranty administrator 52 answers to higher corporate authority within the corporation 12 that is beyond the scope of this invention. As shown in FIG. 1A, for purposes of the present invention and ultimately the reimbursement of the customer 58, a final review and approval of a claim by the warranty administrator 52 allows the accounting department 56 to release funds to the customer 58 as will be discussed below.

Within the distributorship system 14, the distributor level 20 provides all sales and service of the corporate manufacturer's product and is the liaison between the customer 58 and the corporate manufacturer 12 for all issues with the product, so that any warranty claims are initiated at this level. When considering after-warranty and off-warranty claims with the present invention, it may be an established corporate policy to give independent distributors 22 or distributor sites 24 the authority to approve or deny claims that seek compensation below a certain monetary value. For example, the predetermined monetary limit in a single claim that a distributor site 24 may approve or deny may be $2000.00. Additionally, each distributor site 24 may be allotted a specific maximum claim approval amount that is not to be cumulatively exceeded over a given time period. It should be appreciated that the maximum cumulative amount may be variable based on the corporate manufacturer's policies and the customer base that the particular distributor site 24 serves. For example, a manufacturer produces industrial engines and contracts a rural distributorship to an individual distributor 22 who operates independently and serves a customer base that consists of 2 small trucking businesses and 45 independent farmers, all totaling sales and service for 100 of the manufacturer's engines. In this example, this particular distributor 22 may be allotted a monthly cumulative claim approval amount of $3000.00 for after-warranty and off-warranty claims. However, the same manufacturer may have a distributorship site 24 that employs 4 distributors and a distributor manager 26 that are responsible for sales and service of thousands of the manufacturer's engines. In this case, the monthly cumulative claim approval amount would be substantially higher. Through the remainder of the specification it should be appreciated that, unless otherwise noted, the use of the term “distributor 22” may refer to an individual, independent distributor, or a distributor at a distributor site 24 that is overseen by a distributor manager 26.

The claim approval limit for distributors 22 merely sets a value above which they may no longer take direct action on the submitted claim. In other words, distributors 22 are precluded from approving claims that exceed the limit, in this example $2000.00. Additionally, when the monthly cumulative claim approval amount is exceeded, distributors 22 may be required to forward all further claims to the next higher level. As the intermediary on behalf of the customer 58, when a single claim exceeds the distributor's approval or deny limit, the distributor 22 must forward the claim on to the next higher level authority for consideration.

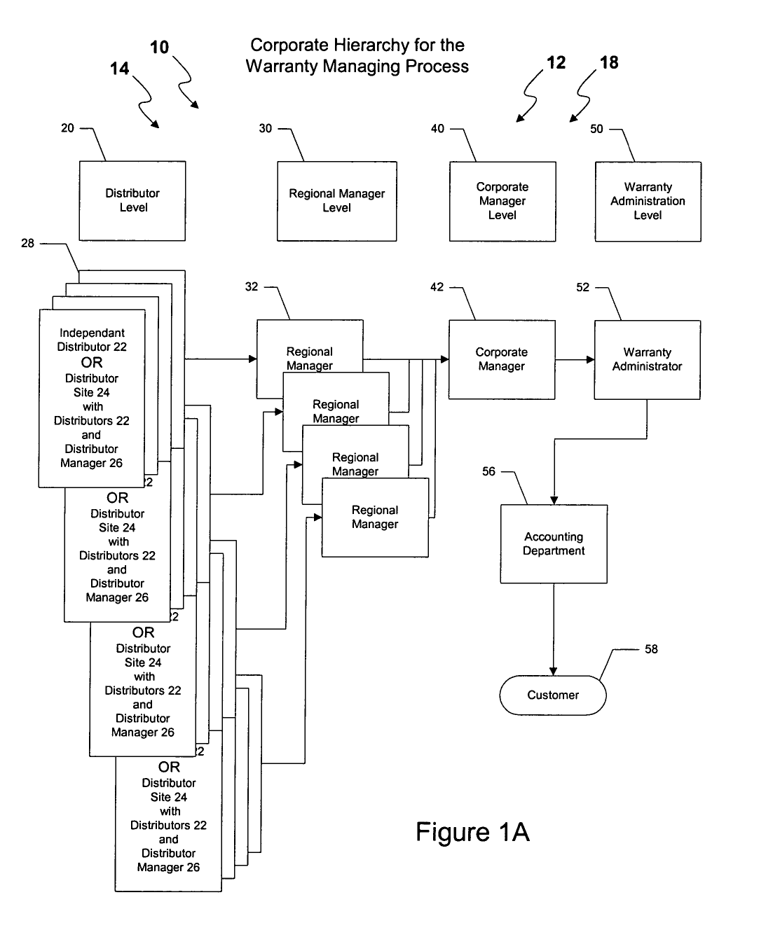

The steps of the warranty managing process 10 are schematically illustrated in the flowchart shown in FIG. 2. As the initial step to processing an after-warranty or off-warranty claim, the customer brings a request for reimbursement or consideration concerning a problem with the manufacturer's product, as shown at block 60, to the distributor level 20, as shown at block 62 in FIG. 2. The distributor 22 or the distributor manager 26 will access the corporate network 3 of the computer system 2 through the Internet website 5, as shown at block 64.

It should be appreciated that the warranty managing process 10 of the present invention is designed to limit the Internet access to the corporate network 3 through the use of computer login identification and passwords established by the corporation. In this manner, the warranty managing process 10 employs any of a variety of known computer security measures, such as user lists and passwords, to limit the various degrees of access allowed to individuals on each level of the corporate structure. It should be further appreciated that the network of the computer system may employ several subsections, or separate branches, such as extranets, intranets, or local area networks (LAN) that are separate and distinct from each other for corporate functions, such as accounting, personnel management, and engineering, but also have the capability to share data and information. It should be still further appreciated, as part of the predetermined corporate structure, that not all of the distributors 22 at a particular distributor site 24 may be given the authority to access the website to initiate a customer claim. More specifically, it may be that only the distributor manager 26 of a multi-distributor site 24 or only particular distributors 22 of a distributor site 24 are authorized to access the website. Thus, the distributor 22 or distributor manager 26 will begin at block 64 by accessing the network through a predetermined security sign-on process to the corporate website 5.

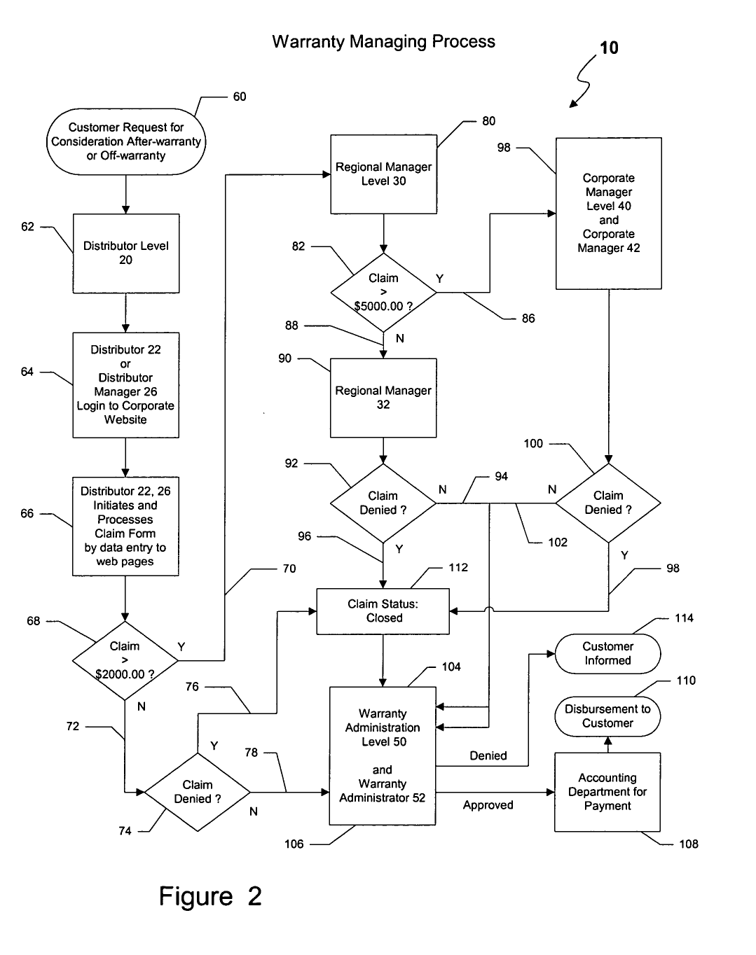

As an example, FIGS. 3-11 are provided to illustrate a “home” page and subsequent interactive web pages that are displayed to an individual who is logged on to the corporate website. It should be appreciated that individual web pages contained within a website may take on an almost endless variety of visual formatting options restrained only by the imagination of the web page designer. Accordingly, those having ordinary skill in the art will appreciate that these screen shots are shown for purposes of illustration, only, and do not serve to limit the scope of the present invention.

An example corporate home page 120 is shown in FIG. 3, which provides the user with a variety of informational links that if selected by “clicking” with the mouse pointer will take the user to other pages of interest about the corporation and products the manufacturer offers. Also available are user “login” and “password” data input blocks, 122 and 124, respectively. These blocks 122, 124 may be used from the home page 120 to sign in as a predetermined and registered user, or the other links may be taken first to move the user onto the other corporate web pages. In this example, the distributor 22 seeking to access the corporate network 3 for claims entry must “login” to move into the corporate network 3 of the manufacturer 12, which may also be used to provide registered members access to other various technical information databases not open to the general public.

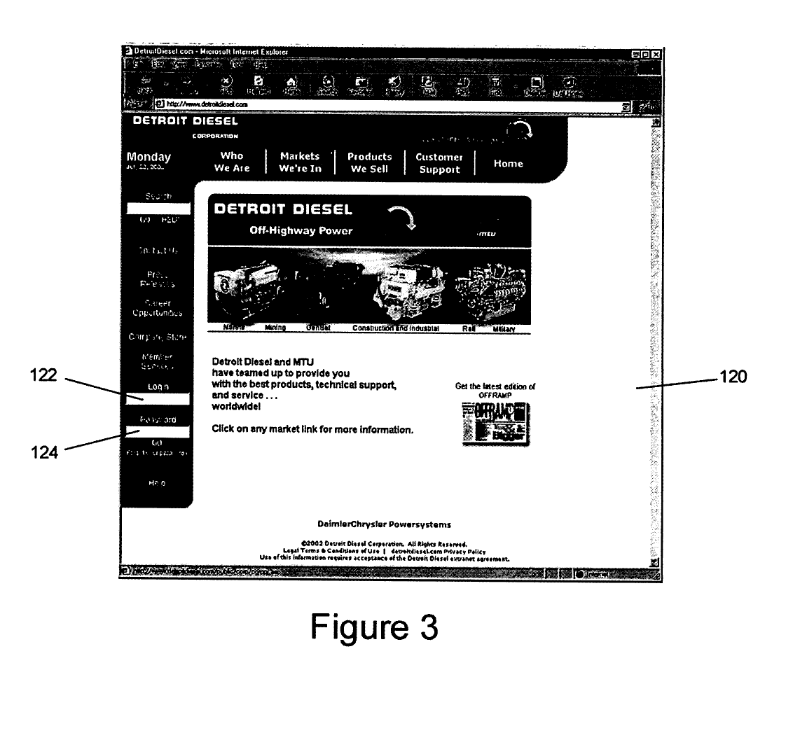

Once “logged in”, FIG. 4 shows the manufacturer's corporate main page 130 and the various links available to the registered members within the manufacturer's corporate network 3. In this example, a distributor 22 would next select the link titled “Return Parts Management System (RPMS)” 132. As discussed above, the warranty managing process 10 of the present invention may be incorporated into a portion of the overall warranty claims process, which in this example is referred to as the “Return Parts Management System (RPMS)”.

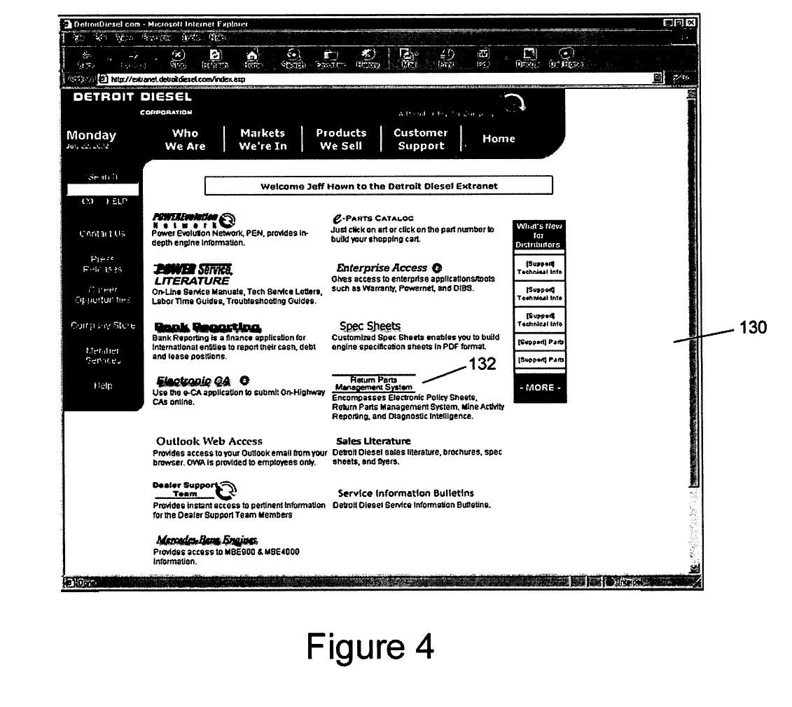

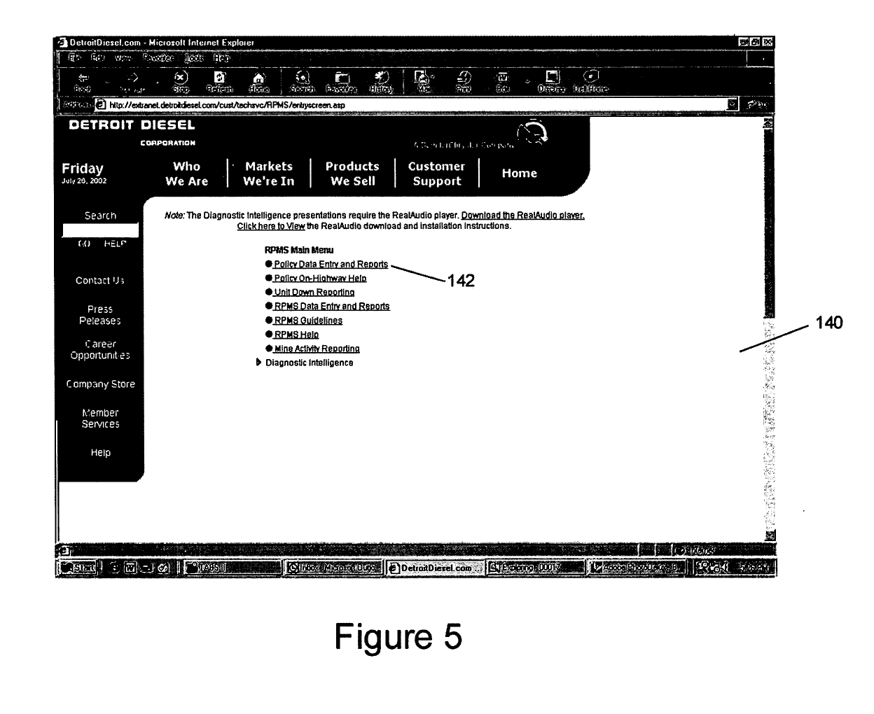

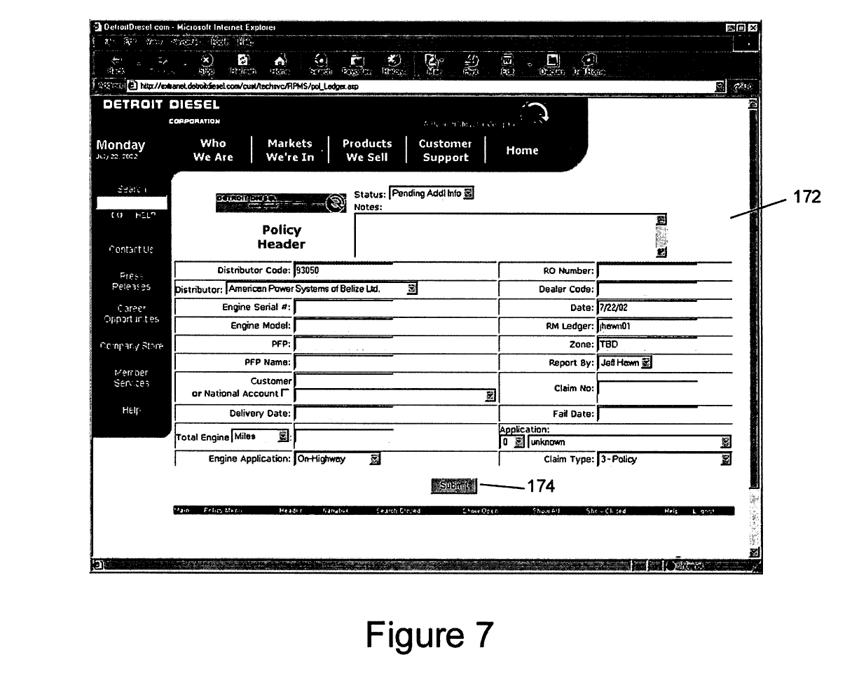

When selected, the link to the RPMS brings the distributor 22 to a RMPS main menu, shown as 140 in FIG. 5. The warranty managing process 10 of the present invention is accessed by the link to “Policy Data Entry and Reports” 142. Based on the level of access provided to the particular user, clicking on the “Policy Data Entry and Reports” 142 link will provide a subsequent web page that has a menu which allows new data entry and review of claim reports that are applicable to that particular corporate level. As shown in FIG. 6, the distributors 22 are provided with a “Policy Distributor Menu” 160 with links identified by the blocks numbered 162-170. As will be discussed below, each higher corporate level will be presented menus that have additional or different links that correspond to their particular corporate level. However, in the Policy Distributor Menu 160 shown in FIG. 6, the links are illustrated as “mouse clickable” buttons and include the following options: Policy Header (162), where new policy claims are initiated; Narrative (164), where the actual description of the problem and the financial data is entered and where items assigned to the distributor 22 can be viewed; and View All Closed (166), which is a list of claims that have been completed for the distributor site 24. View All Closed (166) provides additional search features that will sort the completed claims by month, claim number, approver, and customer. Links in the sorted list also allow the user to view individual claims. In addition, the menu 160 includes a link to View All Open (168), which is a list of claims that are still open for the distributor site 24. The list will contain links to view the claim reports. If the logged in user is responsible for the particular claim, there will be a link to the narrative portion of the claim (FIG. 8) to revise or approve the claim. The link to View Closed Cnt: (170) includes a report showing dollar totals for a selected month, separated by approved and denied requests.

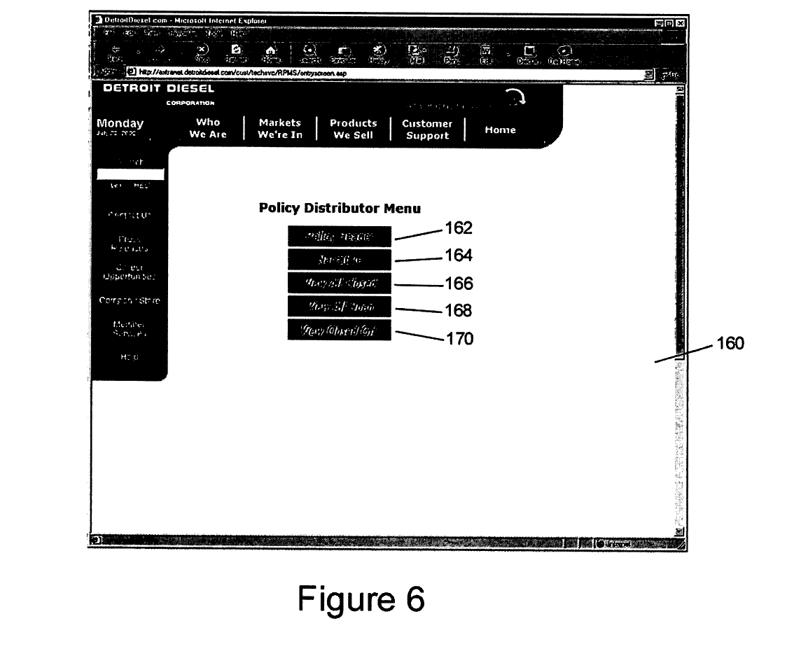

Thus, as shown at block 66 of FIG. 2, the method steps of the present invention begin by inputting the claim through a computer to a database at a first management level. More specifically, the distributor 22 will click the “Policy Header” button 162 (FIG. 6) on the Policy Distributor Menu 160 to initiate the claim. The policy header form 172, shown in FIG. 7, will appear and the distributor 22 will add the applicable information to the blocks until the form 172 is complete as possible. Then the distributor 22 will click on the “submit” button 174 once the form is complete. The narrative page in FIG. 8 will then automatically come up and provide the narrative form 176 to the distributor 22. Block 66 in FIG. 2 then continues as the distributor 22 completes the narrative description of the problem. If not all of the information is available at the time the distributor 22 is filling out the narrative form 176, then it may be saved and returned to later by reopening the claim and using the “Narrative” button 164 from the Policy Distributor Menu 160, in FIG. 6.

To complete the narrative form 176, the distributor 22 fills in any monetary values for the parts and labor that are applicable in the cost portion, generally indicated at 178. Since these claims relate to after-warranty and off-warranty claims, typically the customer 58 will have already expended some known amount to rectify the problem and is asking for specific reimbursement. However, in some cases, the failed or malfunctioning product may not yet have been serviced and along with the claim requesting assistance from the manufacturer, the customer 58 is submitting estimates of the costs to repair the product. To allow the distributor 22, or higher level corporate authority, to properly evaluate the cost to the corporate manufacturer 12, blocks are available for the distributor 22 to fill in comparative values for costs relating to “parts” and “labor” that would be expended by the distributor 22 and the manufacturer 12 to complete the repairs. Additionally, “mark-up” 180 and “net cost” 182 blocks are also available to reflect true as opposed to relative valves. The figures input into the blocks are summed automatically by column and row with subtotals provided in the blocks to the bottom and to the right and an overall claim total is provided as indicated at block 184.

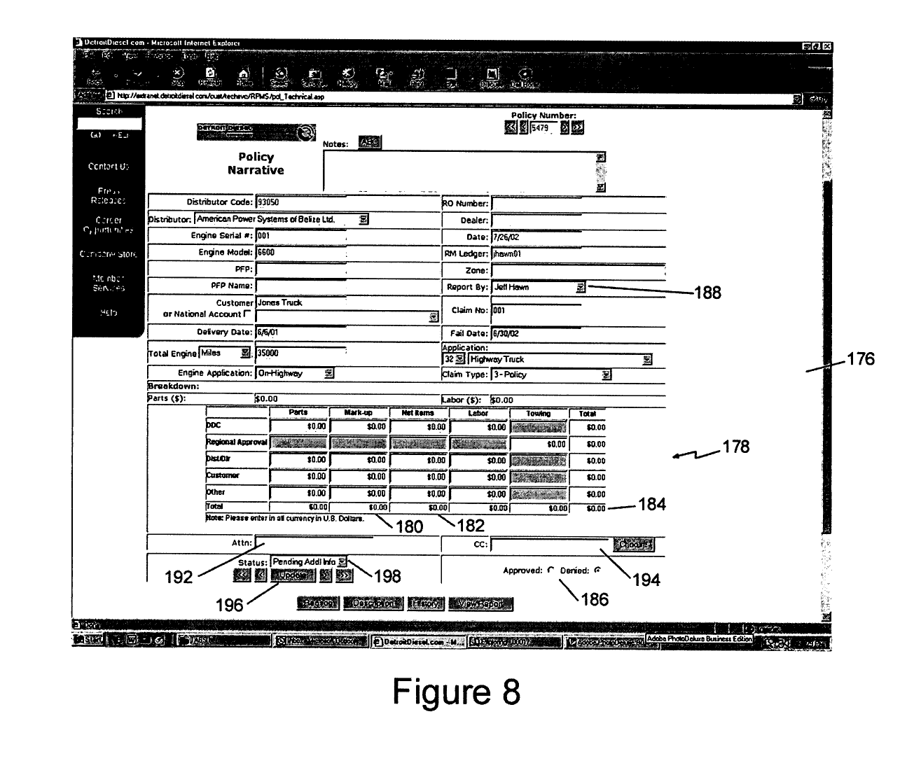

Thus, the next method step of determining the value of the claim is automatically accomplished as the monetary values are filled in. In this manner, the decision block 68 in FIG. 2 is an automatic function built into the design of the narrative form web page 176. If the distributor 22 is submitting a claim requesting policy consideration in which the total exceeds a first predetermined maximum approval amount (which in this example is $2000.00) then a pop-up message box 210, as shown in FIG. 9, will appear signaling the distributor that his maximum approve/deny limit has been met. Also, the “Approve/Deny” option buttons 186 at the bottom of the narrative form 176 will no longer be available. Referring to the decision block 68 in FIG. 2, when the claim does exceed the approve/deny limit (i.e., Is the claim greater than $2000.00?), then the “YES leg 70 is taken and the responsibility for the claim is forwarded to the regional manager level 30 (block 80, FIG. 2). Specifically, as the distributor 22 finishes the claim, the claim is stored in the corporate database 4 in a pending status and it is assigned to the distributor's regional manager 32. A policy report of the claim is sent, by email, to that particular regional manager 32 informing the manager that the claim has become his/her responsibility.

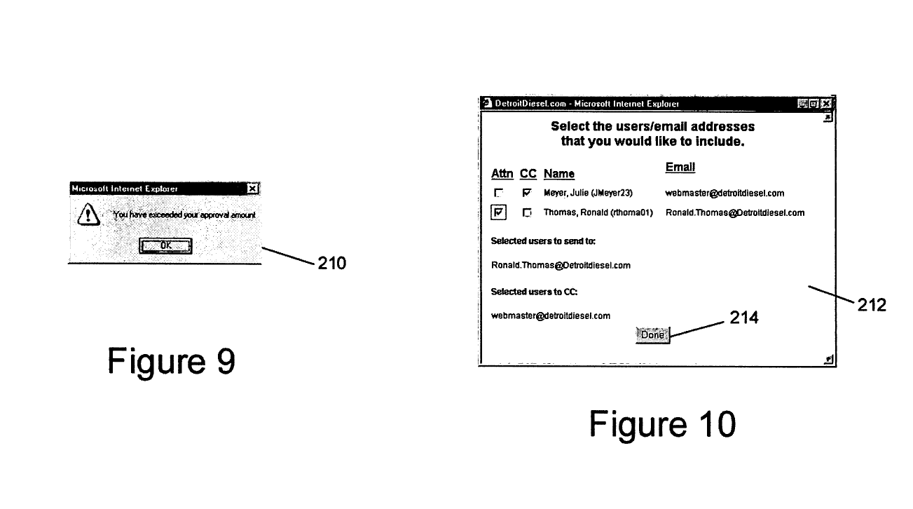

When the distributor 22 is signaled by the pop-up message box 210 that the approve/deny limit has been exceeded and the “Approval/Deny” button 186 is no longer available, then the distributor 22 changes the name in the “Report By:” drop down box 188. The “Report By:” drop down box 188 normally shows the name of the logged in distributor 22 as a default, but it also contains a list of the regional managers 32. The distributor 22 will select his regional manager 32 from the list and then point to, and click on the “Choose” button 190 at the bottom. This brings up an information window 212 as shown in FIG. 10, which shows the distributor 22 the usernames and e-mail addresses to which a report notification will be sent. The distributor 22 may also fill in additional “Attn:” 192 and “CC:” 194 email addresses before selecting the “Choose” button 190. These additional names and addresses from the “Attn:” 192 and “CC:” 194 blocks will also appear in the information window 212. The distributor 22 then selects the “Done” button 214 in the information window 212, which sends out the policy report emails. Finally, the distributor 22 clicks on the “Update” button 196 to store the claim in the database of the computer network.

If in the decision block 68 of FIG. 2, the first predetermined amount has not been reached (meaning the $2000.00 approve/deny limit), then the “NO” leg 72 is taken to decision block 74 and the distributor 22 may approve or deny the claim as he sees fit. In this case, the pop-up message box 210 does not appear and the distributor 22 may select either one of the “Approve/Deny” buttons 186 at the bottom of the narrative form 176. Thus, the first management level (distributor level 20) acts to approve or deny the claim when the value of the claim is below a first predetermined amount ($2000.00), and an approval or denial of the claim is input to the database at the first management level when the value of the claim is below the first predetermined amount. By the approval or denial, the distributor 22 is performing a closing action on the claim and he must change the “Status:” block 198 on the bottom of the narrative form 176 from its default of “Pending” to “Closed”. The distributor 22 will then click on the “Choose” button 190 to automatically select the warranty administrator 52 as the email recipient of the policy report.

If the distributor 22 has denied the claim at decision block 74, the “YES” leg 76 is followed and the claim is placed in the closed status at 112 and the customer will be informed through administrative channels as indicated at step 114. The claim is still stored in the corporate database 4 and the regional manager 32 is emailed. If the distributor 22 has approved the claim, the warranty administrator 52, through the warranty administration level 50 is informed for a final review, as shown in blocks 104 and 106 of FIG. 2. It is the warranty administrator's 52 responsibility to do a cursory review of the claim and insure that it is properly completed within corporate guidelines. In this final review of a distributor approved claim, the warranty administrator 52 may request additional information from the distributor 22 or the customer 58 to insure proper adherence to the corporate policy. Claims approved by the warranty administrator 52 are sent to an accounting department for payment to the customer in satisfaction of the claim, or to reimburse the distributor site if the distributor had already paid the claim as indicated at steps 108 and 110.

Additionally, the distributor level 20 is given the discretion and authority to approve portions of submitted claim requests and negotiate reimbursements for only some of a submitted claim rather than either fully approving or flatly denying a claim. This authority is given by the corporate manufacturer to further customer relations and goodwill at the level closest to the customer. Since the majority of these types of policy claims are for relatively small dollar amounts, this delegation to the distributor level 20 reduces the burden on the upper levels of the corporate structure by allowing those familiar with the customer to handle most of the policy claims in an expeditious and affable manner.

When the amount of the policy claim is greater than the first predetermined amount ($2000), the claim is forwarded on by the “YES” leg 70 of decision block 68 to the second management level (i.e., the regional manager level 30) in block 80. In a like manner to the distributor level 20, the regional managers 32 have a maximum approve/deny limit set at a second predetermined value. In continuing the same example, the approve/deny limit for regional managers 32 is $5000.00. When a policy claim is forwarded from the distributor level 20 that exceeds their $2000.00 maximum approval limit, decision block 82 is reached at the regional level 30. Thus, the method of the present invention provides the step of a second management level acting to review all claims input at the first management level and acting to approve or deny the claim when the value of the claim is above the first predetermined amount ($2000) and below a second predetermined amount ($5000).

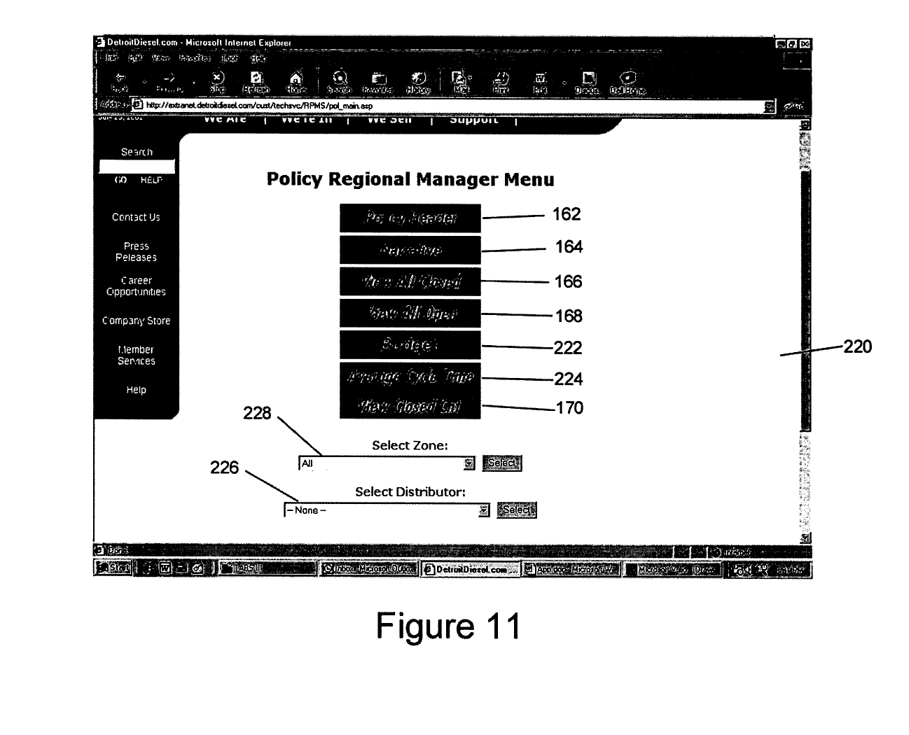

In regard to a particular claim, if during the routing process illustrated in FIG. 2 at decision block 82, the $5000.00 approval limit has not been reached, then the “NO” leg 88 is taken and the claim will be available to the regional manager 32 (block 90) for his approval or denial as he sees fit, based on a predetermined corporate criteria. The regional manager 32 is provided with the Policy Regional Manager Menu 220 as shown in FIG. 11, which has the same link buttons numbered 162-170 as those on the Policy Distributor Menu 160 in FIG. 6. As a continuation of the claim process, the regional manager 32 will use the View All Open 168 button link to review all the currently pending policy claims stored in the database that have been generated within his region. When the View All Open 168 button is selected, a list of the pending claims will be provided so that the regional manager 32 may sort through and choose any individual claim to open. Opening of any individual claim will display the stored claim information in its Policy Narrative page 176 (FIG. 8).

For each claim, the regional manager 32 may then select either one of the “Approve/Deny” buttons 186 at the bottom of the narrative form 176. Thus, the method of the present invention provides the step of a second management level (regional manager 32) inputting an approval or denial of the claim to the database when the value of the claim is above the first predetermined value and below the second predetermined value.

By selecting either approval or denial, the regional manager 32 is performing a closing action on the claim and he must change the “Status:” block 198 on the bottom of the narrative form 176 from its default of “Pending” to “Closed”. The regional manager 32 will then click on the “Choose” button 190 to automatically select the warranty administrator 52 as the email recipient of the policy report. Additionally, the regional manager 32 has the discretion and authority to approve only certain portions of submitted claim requests and negotiate reimbursements for portions of a submitted claim rather than either fully approving or flatly denying a claim.

The regional manager 32 will also be able to access all closed claims using the View All Closed 166 button from the Policy Regional Manager Menu 220, which will show a list of all the closed claims generated in that particular region. Options are available for sorting the claims by time periods and/or by distributors. Additionally, a report of the closed claims from the region is available showing the dollar totals using the View All Closed Cnt 170. It should be appreciated that although the regional manager 32 is also given the ability to generate individual policy claims by using the Policy Header and Policy Narrative buttons 162 and 164 on the Policy Regional Manager Menu 220, it is not a preferred practice within the process of the present invention and would only be used in exceptional circumstances. The other link button on the Policy Regional Manager Menu 220 that are not on the Policy Distributor Menu 160 will be discussed in greater detail below.

Again in regard to a particular claim, if during the routing process illustrated in FIG. 2 at decision block 82 the policy claim is larger than the second predetermined amount ($5000.00), then the responsibility for the claim will be forwarded on by the “YES” leg 86 of decision block 82 to the third management level, for example, the corporate level 40, and in particular the corporate manager 42. In this case, since the claim amount exceeds the second predetermined amount, the regional manager 32 will not be provided the “Approve/Deny” buttons 186 (FIG. 8) to act directly upon the submitted claim. The routing a of larger claim through the regional manager 32 first properly assigns the policy claim to the particular regional manger 32, which allows the regional manager 32 to be aware of and monitor all the claims originating in his region that are over the second predetermined amount ($5000.00).

The corporate manger 42 will personally involve himself with the customer 58 and the situation that has brought about a claim of this amount. It should be appreciated that any of a variety of economic concerns will direct the corporate policy that guides the corporate manager's 42 dealing with the customer 58. Factors such as the particular customer 58 and its current business dealings with the corporate manufacturer 12, as well as the speculative possibility of any future dealings with the customer 58 may influence the denial or the amount of approval of the claim. These corporate decisions for denial or approval of an after-warranty or an off-warranty claim and any predetermined criteria that would form the basis for these decisions are well beyond the scope of this invention.

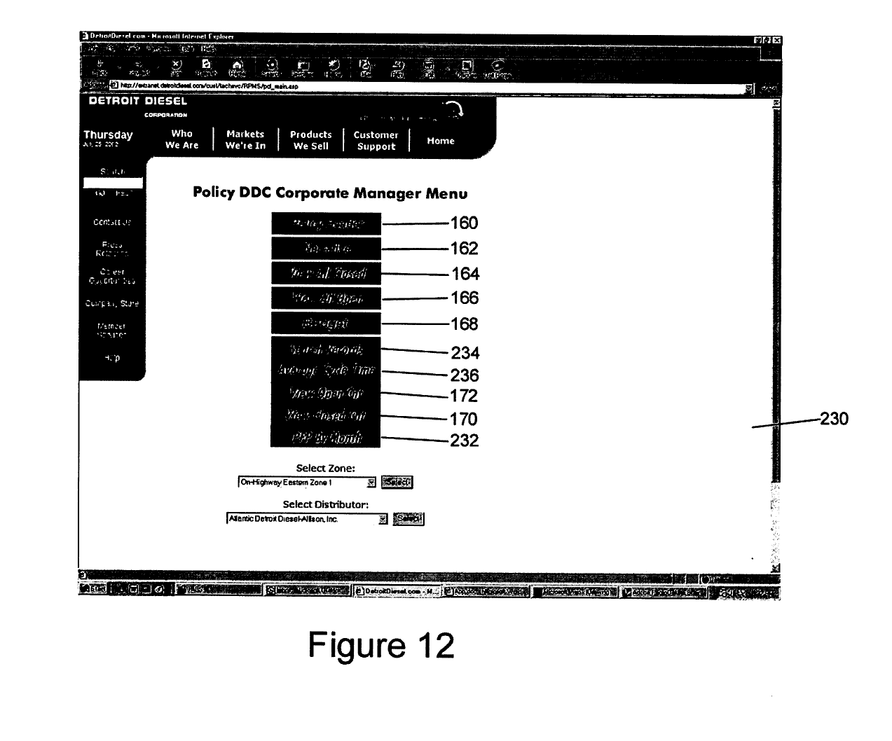

The corporate manager 42 is provided with the Policy Corporate Manager Menu 230 as shown in FIG. 12, which has the same link buttons numbered 162-170 as those on the Policy Distributor Menu 160 in FIG. 6 and the Policy Regional Manager Menu in FIG. 11. As a continuation of the claim process, the corporate manager 42 will use the View All Open 168 button link to review all the currently pending policy claims stored in the database that have been generated within the entire corporation. When the View All Open 168 button is selected, a list of the pending claims will be provided so that the corporate manager 42 may sort through and choose any individual claim to open. Opening of any individual claim will display the stored claim information in its Policy Narrative page (FIG. 8). Thus, the method of the present invention provides the step of a third management level acting to review all claims input at the first and second management levels.

In regard to a particular claim, if during the routing process illustrated in FIG. 2 at decision block 100, the corporate manager 42 denies the policy claim, then the “NO” leg 102 is taken and the closed claim will be available to the warranty administration level 50 (block 106) to notify the customer of the claim denial (block 114). If the corporate manager 42 approves the policy claim, then the “YES” leg 98 of decision block 100 is taken and the approved policy claim is available for the review of the Warranty Administrator 52 (block 106). The policy claim is either approved or denied when the corporate manager 42 selects either one of the “Approve/Deny” buttons 186 at the bottom of the narrative form 176 (FIG. 8). In this manner, the method of the present invention provides the step of a third management level acting to approve or deny the claim when the value of the claim is above the second predetermined amount. Further, the step of inputting an approval or denial of the claim to the database at the third management level when the value of the claim is above the second predetermined amount is provided.

By selecting either approval or denial, the corporate manager 42 is performing a closing action on the claim and he must change the “Status:” block 198 on the bottom from its default of “Pending” to “Closed”. The corporate manager 42 will then click on the “Choose” button 190 to automatically select the fourth management, or warranty administration level 50 as the email recipient of the policy report. Additionally, the corporate manager 42 has the discretion and authority to approve only certain portions of submitted claim requests and negotiate reimbursements for portions of a submitted claim rather than either fully approving or flatly denying a claim.

The corporate manager 42 will also be able to access all closed claim requests using the View All Closed 166 button from the Policy Regional Manager Menu 230, which will show a list of all the closed claims generated in the corporation. Options are available for sorting the claims by time periods, distributors, and regions. Additionally, a report all closed policy claims and all open policy claims is available showing the dollar totals using the View All Closed Cnt 170 and View All Open Cnt 172, respectively. These are also sortable by time periods, distributors, and regions. It should be appreciated that although the corporate manager 42 is also given the ability to generate individual policy claims by using the Policy Header and Policy Narrative buttons 162 and 164 on the Policy Corporate Manager Menu 230, it is not a preferred practice within the process of the present invention and would only be used in exceptional circumstances. The other link buttons on the Policy Corporate Manager Menu 230 that are not on the Policy Distributor Menu 160 or the Policy Regional Manager Menu 170 will be discussed in greater detail below.

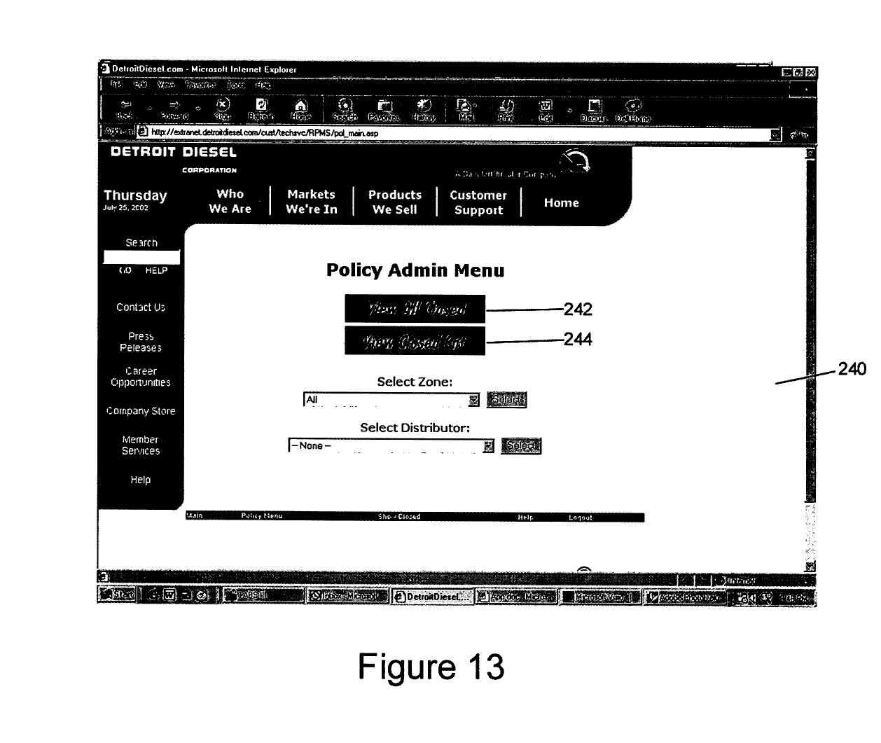

Similarly, the warranty administrator 52 is provided with the Policy Warranty Administrator Menu 240 as shown in FIG. 13. This menu requires very few link buttons as the warranty administrator 52 is only reviewing claims that are closed and are sent through him for final review. Thus, the method of the present invention provides the step of a fourth management level (warranty administration level 50) acting to review all approved claims for accuracy and completeness. Further, the steps of a fourth management level acting to inform the customer when a claim is denied and acting to inform an accounting management level when a claim has been approved, thereby directing the accounting management level to reimburse the customer is provided. As with the other menus, the links “View All Closed” 242 and “View Closed Cnt” 244 provide a list of claims that have been closed by the lower levels and provide reports showing dollar totals for a selected month, separated by approved and denied requests, respectively.

As previously mentioned, the different management levels are shown different RMPS menus when they login to the system. As shown in FIG. 11, the regional manager 32 is given access to the Policy Regional Manager Menu 220 with two more links than the Policy Distributor Menu 160 shown in FIG. 6. The additional link, “Budget” 222 allows the regional manager 32 to select a particular distributor 22 using the drop-down distributor list 226 from a particular area, or one of the zones that the regional manager controls using the drop-down zone list 228. This allows the regional manager 32 to view the allotted corporate policy budget for that particular distributor or zone on-screen. The regional manager 32 can also see how much of the budget the distributor 22 is expending up to date and may review past budget expenditures month by month. The additional link, “Average Cycle Time” 224 also allows the regional manager 32 to select a particular distributor 22 and to view the distributor's cycle time for the completion of customer claims. In other words, the regional manager 32 can graphically view the time it takes for the distributor 22 to either approve or deny customer claims. In both cases, the data is extracted directly from the database and may be presented in a variety of display or report options.

In a like manner, the Policy Corporate Manager Menu 230 as illustrated in FIG. 12, has additional links that differ from the Policy Regional Manager's Menu 220. The “Budget” 234 and “Average Cycle Time” 236 links work as described above in reference to the Policy Regional Manager's Menu 220. The “Search Records” 230 link allows the corporate manager 42 to review both individual claims and groups of claims from particular distributors 22, or distributor groups 28. The “PFP by Month” 232 link shows the corporate manger 42 the claims by a “primary failed part” criteria for tracking of failure rates of the individual component parts as reported by the customers. Thus, for engineering or safety purposes, it can be noted when particular parts or portions of the product have a high failure rate. In addition, for accounting purposes, it may be observed when repair costs are higher than expected for certain parts or assemblies within the product.

In this manner, it should be appreciated by those having ordinary skill in the art that the present invention provides distinct advantages over the prior art. The warranty managing process includes a plurality of steps that move customer after-warranty and off-warranty claims through various levels of the corporate structure for review and disposition. More specifically, the present invention provides a formalized process to initiate a customer claim at the lower management levels for approval or denial and then expeditiously moves the claim through the higher management levels for review. This delegation unburdens the higher levels of corporate management from the details of the claim approval and denial process and allows the distributor, closest to the customer, to decide the validity of the claim below a predetermined dollar amount. The present invention also provides the lower management level access to a database system for the direct entry of claim information through a website. This feature eliminates the massive, inefficient paper trail of previous processes of this type. The present invention also avoids the confusion of the sporadic and uncontrolled claim submissions of conventional processes, which are most often generated and forwarded in various incompatible submission formats. In this manner, the present invention greatly reduces the claim turn around time over conventional processes, thereby expeditiously assisting customers with their claim requests and ensuring good customer relations.

The warranty managing process further includes the advantage of using a computer system having a local network with at least one database for the storage of information, and provides internet access through a corporate website. This provides access and retrieval of the entered data from the database by each of the plurality of corporate levels for processing, monitoring and control of the warranty managing process at any time from any location in which a computer with internet access is available. This ability of higher levels of management to access the claim data provides an efficient system of checks and balances for monitoring claim processing and budgetary control, while reducing paper work and increasing efficiency of response time. The database storage of claim information also allows other departmental groups within the corporate structure, such as accounting, safety, and engineering, to utilize the product failure and cost information.

The invention has been described in an illustrative manner. It is to be understood that the terminology that has been used is intended to be in the nature of words of description rather than of limitation. Many modifications and variations of the invention are possible in light of the above teachings. Therefore, it should be appreciated that the invention may be practiced other than as specifically described.

We claim:

1. A method of processing a customer claim against a manufacturer's product, said method includes the steps of:
inputting the claim through a computer to a database at a first management level;
determining the value of the claim;
approving or denying the claim at the first management level when the value of the claim is below a first predetermined level;
a second management level acting to review all claims input at the first management level and acting to approve or deny the claim when the value of the claim is above the first predetermined level and below a second predetermined level; and
a third management level acting to review all claims input at the first and second management levels and acting to approve or deny the claim when the value of the claim is above the second predetermined level.

2. A method as set forth in claim 1, which further includes the steps of:
providing a fourth management level to review all approved claims for accuracy and completeness and to inform the customer when a claim is denied and to inform an accounting management level when a claim has been approved and direct the accounting management level to reimburse the customer.

3. A method as set forth in claim 1 wherein the step of inputing a claim through a computer further includes the steps of accessing the corporate database through a computer connected to a corporate network, and opening a new record file for the customer claim.

4. A method as set forth in claim 3 wherein the step of accessing the corporate database through a computer connected to a corporate network further includes the step of entering a predetermined login name and a predetermined password to request access.

5. A method as set forth in claim 3 wherein the step of accessing the corporate database through a computer connected to a corporate network further includes the steps of accessing the internet through any capably equipped computer, electronically accessing a world wide web interface to the corporate network, and electronically connecting the computer to the corporate network through the internet and world wide web connections.

6. A method as set forth in claim 5 wherein the step of electronically connecting the computer to the corporate network through the internet and world wide web connections further includes the step of entering a predetermined login name and a predetermined password to request access.

7. A method as set forth in claim 6 wherein the step of inputing a claim through a computer further includes the step of selecting from a menu at least one operational link to another page for input of claim specific data.

8. A method of processing a customer claim as set forth in claim 1 wherein the steps of inputting an approval or denial of the claim further includes the steps of accessing the corporate database through a computer connected to a corporate network, and opening a new record file for the customer claim.

9. A method as set forth in claim 8 wherein the step of accessing the corporate database through a computer connected to a corporate network further includes the step of entering a predetermined login name and a predetermined password to request access.

10. A method as set forth in claim 8 wherein the step of accessing the corporate database through a computer connected to a corporate network further includes the steps of accessing the internet through any capably equipped computer, electronically accessing a world wide web interface to the corporate network, and electronically connecting the computer to the corporate network through the internet and world wide web connections.

11. A method as set forth in claim 10 wherein the step of electronically connecting the computer to the corporate network through the internet and world wide web connections further includes the step of entering a predetermined login name and a predetermined password to request access.

12. A method as set forth in claim 11 wherein the step of a second management level acting to review all claims input at the first management level further includes the step of selecting from a menu at least one operational link to another page to generate a list of all open claims.

13. A method as set forth in claim 12 wherein the step of a second management level acting to review all claims input at the first management level further includes the step of selecting one claim file from the list of all open claims to select a specific claim to review.

14. A method as set forth in claim 13 wherein the step of a second management level acting to approve or deny the claim further includes the step of selecting either an approve or a deny web page button to indicate the decision.

15. A method as set forth in claim 11 wherein the step of a third management level acting to review all claims input at the first and second management levels further includes the step of selecting from a menu at least one operational link to another page to generate a list of all open claims.

16. A method as set forth in claim 15 wherein the step of a third management level acting to review all claims input at the first and second management levels further includes the step of selecting one claim file from the list of all open claims to select a specific claim to review.

17. A method as set forth in claim 15 wherein the step of a third management level acting to approve or deny the claim further includes the step of selecting either an approve or a deny web page button to indicate the decision.

18. A method as set forth in claim 11 wherein the step of requiring a fourth management level to review all approved claims for accuracy and completeness further includes the steps of selecting from a menu at least one operational link to another page to generate a list of all open claims and selecting one claim file from the list of all open claims to select a specific claim to review.

19. A method of processing a customer claim against a manufacturer's product when the claim is made for repair or replacement of the product after the expiration of a specified warranty period, said method includes the steps of:
inputting the claim through a computer to a database at a first management level;
determining the value of the claim;
approving or denying the claim at the first management level when the value of the claim is below a first predetermined level;
a second management level acting to review all claims input at the first management level and acting to approve or deny the claim when the value of the claim is above the first predetermined level and below a second predetermined level;
a third management level acting to review all claims input at the first and second management levels and acting to approve or deny the claim when the value of the claim is above the second predetermined level; and
providing a fourth management level to review all approved claims for accuracy and completeness and to inform the customer when a claim is denied and to inform an accounting management level when a claim has been approved and direct the accounting management level to reimburse the customer.

20. A method of processing a customer claim against a manufacturer's product when the claim is made for ancillary costs arising from customer expenses associated with the servicing of the product while still within the manufacturer's specified warranty period, said method includes the steps of:
inputting the claim through a computer to a database at a first management level;
determining the value of the claim;
approving or denying the claim at the first management level when the value of the claim is below a first predetermined level;
a second management level acting to review all claims input at the first management level and acting to approve or deny the claim when the value of the claim is above the first predetermined level and below a second predetermined level;
a third management level acting to review all claims input at the first and second management levels and acting to approve or deny the claim when the value of the claim is above the second predetermined level; and
providing a fourth management level to review all approved claims for accuracy and completeness and to inform the customer when a claim is denied and to inform an accounting management level when a claim has been approved and direct the accounting management level to reimburse the customer.
